(19) United States
(12) Patent Application Publication
(10) Pub. No.: US 2004/0130208 A1
(43) Pub. Date: Jul. 8, 2004

(54) Torque control system dependent on wheel load in a drive mechanism

(76) Inventors: Conrad Muller, Waldbrunn (DE); Otto Adalbert Maria Kneuer, Eibelstedt (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/470,443

(22) PCT Filed: Jan. 24, 2002
(86) PCT No.: PCT/DE02/00225

(30) Foreign Application Priority Data
Jan. 27, 2001 (DE) 101 03 635.3

(51) Int. Cl. B60T 8/56

(52) U.S. Cl. 303/142; 303/151

(57) ABSTRACT

The invention relates to a torque control system which is dependent on wheel load in a drive mechanism for crane crabs, preferably machinery house crabs of container crabs, consisting of a drive mechanism, crab wheels, craneways and transfer elements. Said control system is characterized in that the wheel load of each wheel is determined and the torque of the drive mechanism for the wheel concerned is adjusted in such a way that there is sufficient static friction between the wheel and its running surface. The inventive solution has the advantage that there is always sullicient torque without slipping on the driven wheel, even in the case of swinging loads and low friction values between the wheels of the crab and the rail.

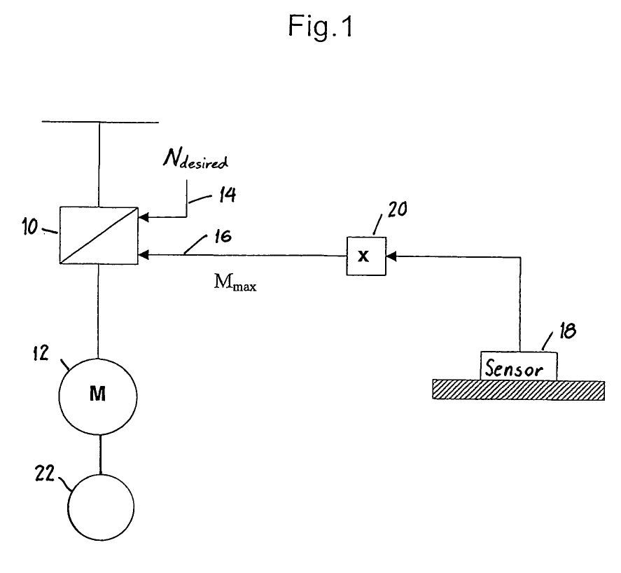

The invention relates to a control system for a drive mechanism of devices (hereinafter called vehicles) on craneways, whereby the wheels on which the vehicle is supported are driven in accordance with the preamble of the first patent claim.

The invention is suited for drive mechanisms of crabs or cranes, in particular it is desirable with regard to machinery house crabs of container cranes that loading and unloading operations may be performed at high speeds regardless of weather conditions. High speeds and acceleration rates, however, cause the drive wheels of the travelling gear to slip, especially in the presence of adverse weather conditions or in case of a significant distance between the vehicle's center of gravity and the craneway or in case of vigorously swinging load.

Various options are known from the prior art for ensuring that wheels do not slip. One option involves stopping or minimizing the pendulum motion of load in order to allow for even distribution of loads to all wheels of the crab drive. DE 19918449 discloses one such method, whereby a procedure and lifting system are implemented for fine positioning and active control of pendulum motion of loads while stacking containers. With the proposed solution it is not possible, however, to avoid an uneven loading of wheels because of horizontal forces.

Another option for improving the adhesion between driven wheels and craneways for drive mechanisms is the selection of suitable materials. Nonetheless, it is not possible to prevent slippage of the wheels of devices based on the prior art especially under wet conditions due to rain as is common with harbor cranes.

The torque applied to the wheel produces, in the contact face between the wheel and craneway, driving force which acts parallel to the contact face and depends on the coefficient of friction between the wheel and craneway. If the static friction is lost due to exceeding the transmittable driving force as a result of unloading the wheel, the driving force is limited to a friction force which is to be transferred by sliding friction and which is significantly lower than the static friction. The wheel slips.

For instance, there is a method know from automotive engineering for controlling drive mechanisms such that it is possible to prevent wheels from slipping even under changing craneway conditions. DE19603677A1 describes a method for controlling drive slippage, in which drive slippage should be controlled without using drive maps or additional sensors in such a way that it is adapted to the characteristics of the craneway surface. In doing so, a setpoint for craneway slippage shall be automatically adapted to various craneway conditions and frictional connection coefficients. This invention's area of application is specifically antilocking systems used in automobiles.

Such methods are not known for drive mechanisms of crane crabs.

It is the object of the invention to develop a drive mechanism for crane crabs, whereby the wheels are driven in such a way that the torque applied to the wheel causes a driving force which is not greater than the static friction force caused by the wheel load, even in case of uneven distribution of load for instance due to swinging or horizontal forces acting on the vehicle.

This object is solved with a drive mechanism based on the characterizing features cited in patent claim 1.

Subclaims reflect additional advantageous embodiments of the invention.

The solution according to the present invention envisages that the wheel load of each wheel is determined and that the torque of the drive mechanism for the respective wheel is constantly adjusted so that there is sufficient static friction between the wheel and its running surface. The wheel load on the individual wheels may be determined with the aid of suitable sensors, for instance, using strain gauges or even by way of computation. Determination of the wheel load is carried out continuously on each single wheel. A signal obtained from the measurement is then transmitted to a computer that, provided a specific wheel load is exceeded, limits the torque of the drive mechanism for the respective wheel. Consequently, there is a possibility for adapting the present torque to the wheel load and the static friction coefficient in order to prevent a slippage of the individual wheel and to utilize a higher limiting force for transferring a greater torque and thus for a higher driving force.

The advantage the present invention offers over previous solutions is that material pairings with relatively lower friction coefficient are possible and that it is possible to omit other additional devices for increasing the friction coefficient. The invention also works with a single-wheel drive, in which the wheels are not coupled mechanically or hydraulically.

The present invention is described below in more detail by way of reference to preferred embodiments. The torque control system dependent on wheel load was implemented on a machinery house crab of a container crane in which the ratio of distance from the crab's gravity center/craneway to wheel spacing is roughly 4:5 and the load which possibly affects the crab's gravity center swings up to 20° in either direction during operation. As a result, the front and rear wheels have different loads, which usually causes the unloaded wheels to slip. The inventive solution allows for determining the loads on all wheels. The obtained signals are transmitted to a computer which limits the torque exerted on each wheel in dependence of the wheel load such that it is no longer possible for the wheels to slip.

1. Torque control system which depends on wheel load in a drive mechanism for crane crabs, preferably machinery house crabs of container cranes consisting of the drive mechanism, crab wheels, craneway and transfer elements is characterized in that the wheel load of each individual wheel is determined and that the torque of the drive mechanism for the concerned wheel is adjusted in such a way that there is sufficient static friction between the wheel and its running surface.

2. Drive mechanism according to claim 1 is characterized in that the wheel load of the wheel is measured constantly, a signal is determined via the extent of the wheel load and is transmitted to a computer which relays a signal to the drive mechanism for limiting the wheel's torque in relation to the wheel load.

3. Drive mechanism according to claim 1 is characterized in that the current wheel load of each individual wheel is calculated in sufficiently short intervals, from which the current torque is controlled in such a way that a slippage of the respective wheel is not possible.
